(19) United States
(12) Patent Application Publication
(10) Pub. No.: US 2026/0106379 A1
(43) Pub. Date: Apr. 16, 2026

(54) BICONICAL ANTENNA SUPPORTED BY A CORSET-STYLED DIELECTRIC SHROUD

(71) Applicant: Massive Light LLC, Spring, TX (US)

(72) Inventor: Bernd Strassner, II, Albuquerque, NM (US)

(21) Appl. No.: 19/320,893

(22) Filed: Sep. 5, 2025

Related U.S. Application Data
(60) Provisional application No. 63/705,733, filed on Oct. 10, 2024.

(51) Int. Cl. H01Q 13/04

(52) U.S. Cl. CPC H01Q 13/04

(57) ABSTRACT

A biconical antenna includes a dielectric corset having a first conical chamber defined therein and a second conical chamber defined therein opposite the first conical chamber. The dielectric corset further defines a passage from the second conical chamber to the first conical chamber. A first conical radiating structure is bonded within the first conical chamber of the dielectric corset. A second conical radiating structure is bonded within the second conical chamber of the dielectric corset. An SMA connector is connected to the second conical radiating structure and has a metal pin extending through the passage to electrically contact the first conical radiating structure and provide RF signals thereto.

### CROSS-REFERENCE TO RELATED APPLICATIONS

This application claims benefit of U.S. Provisional Application No. 63/705,733, filed Oct. 10, 2024, entitled BICONICAL ANTENNA SUPPORTED BY A CORSET-STYLED DIELECTRIC SHROUD (Atty. Dkt. No. MASS90-00020), the specification of which is incorporated by reference herein in its entirety.

### TECHNICAL FIELD

The following disclosure relates to antenna structures.

### BACKGROUND

As desired wireless data rates and bandwidths continue to grow, antenna performance often limits wireless system performance. Modern wireless systems commonly compensate for antenna limitations—such as distortion of wideband signals—by hopping between numerous narrow frequency bands within a larger bandwidth, with each frequency band (or channel) operating in a particular time window, rather than instantaneously transmitting and receiving across the entirety of a wide bandwidth.

Conical antennas, such as discones and bicones, have been used for omni-directional, wideband operation. Pattern stability over a wide bandwidth, however, remains a challenge because conical antenna size relative to wavelength varies substantially across a wide bandwidth. Wideband conical antenna radiation patterns thus scan over frequency, an undesirable feature in wireless communications—where an operator may desire to communicate point-to-point or broadcast—and signals intelligence applications—where an operator may desire to instantaneously observe signals that could originate from any direction.

Spherical or elliptical antennas have also been used for omni-directional, wideband operation, but with the same beam-scanning issues as conical antennas. Furthermore, to achieve wide bandwidth, spherical or elliptical antennas are often made “fatter,” increasing the antenna's lateral dimensions. Accordingly, wideband spherical antenna dimensions exceed a half wavelength at higher frequencies, limiting use in multi-antenna configurations, such as antenna arrays. Large antenna sizes for wideband antennas, particularly those operating at low frequencies, also limit use of wide-bandwidth conical antennas in multi-antenna applications that improve wireless system performance.

Conical, spherical, and elliptical antennas remain heavy, costly, and difficult to fabricate and assemble for diverse wireless applications. These antennas are sensitive to fabrication tolerances and detuning issues near the antenna feed point due to high field strength in that region. Conical, spherical, and elliptical antennas often place a heavy, conducting cone, sphere, or ellipse over a ground plane, or over another cone, sphere, or ellipse. This approach rests a large, heavy radiating structure on a small feed pin and cannot operate in harsh environments.

Conical and spherical or elliptical antennas also require a ground plane of significant size to maintain match at lower operating frequencies; otherwise, antenna size becomes prohibitive at low frequency. Operation without a large ground plane causes placement sensitivity, in which the antenna placement, particularly above or near conducting objects excites undesirable modes of operation, distorts wideband signals, detunes the antenna, and causes instability and unpredictability in radiation patterns.

Wideband planar antennas, including planar formulations of conical and spherical antennas, incorporate the limitations described above. Moreover, planar antennas also lack the ruggedness needed to operate in diverse environments, such as unmanned aerial systems where deployment, shock, and vibration require ruggedized structures. Although easy to integrate with planar transceiver circuits, planar antennas must also interface with coaxial connectors in many applications, resulting in a connector-board interface susceptible to failure in harsh environments.

In many instances, UWB antennas that operate over wider bandwidth transition between modes undesirably across the bandwidth of operation, preventing use in wireless applications that require a stable phase center, low distortion, and controlled radiation patterns.

Due to the limitations summarized above, conventional UWB antennas fail to achieve wide instantaneous bandwidth (IBW) and stable and controlled omni-directional patterns, as desired in modern wireless applications. For wireless communications and signals intelligence applications, operators employ multiple antennas to cover relevant bandwidths and remain unable to instantaneously receive or identify wideband signals.

Accordingly, there is a need for antennas operating over a wide instantaneous bandwidth (IBW), particularly antennas having both wide IBW and other features, such as ruggedness, low size and weight, placement-insensitivity, omni-directional radiation, and stable operation across frequency.

### SUMMARY

The present invention, as disclosed and described herein, in one aspect thereof comprises a biconical antenna including a dielectric corset having a first conical chamber defined therein and a second conical chamber defined therein opposite the first conical chamber. The dielectric corset further defines a passage from the second conical chamber to the first conical chamber. A first conical radiating structure is bonded within the first conical chamber of the dielectric corset. A second conical radiating structure is bonded within the second conical chamber of the dielectric corset. An SMA connector is connected to the second conical radiating structure and has a metal pin extending through the passage to electrically contact the first conical radiating structure and provide RF signals thereto.

### BRIEF DESCRIPTION OF THE DRAWINGS

For a more complete understanding, reference is now made to the following description taken in conjunction with the accompanying Drawings in which:

FIG. 1 illustrates a cross-sectional side view of a large corset biconical antenna;

FIG. 2 illustrates a bottom perspective view of the large corset biconical antenna;

FIG. 3 illustrates a top perspective view of the large corset biconical antenna;

FIG. 4 illustrates a cross-sectional side view of a small corset biconical antenna;

FIG. 5 illustrates a bottom perspective view of the small corset biconical antenna;

FIG. 6 illustrates a top perspective view of the small corset biconical antenna;

FIG. 7 illustrates a return loss over frequency curve;

FIG. 8 illustrates a gain over frequency curve for large corset biconical antenna;

FIGS. 9A and 9B illustrate elevation gain patterns from 2 GHz to 16 GHz;

FIG. 10 illustrates the group delay computed from the large antenna's S₂₁ phase slope; and

FIG. 11 illustrates a base substrate and a metalized layer of the upper and lower antenna cones.

### DETAILED DESCRIPTION

Referring now to the drawings, wherein like reference numbers are used herein to designate like elements throughout, the various views and embodiments of a biconical antenna supported by a corset-styled dielectric shroud are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

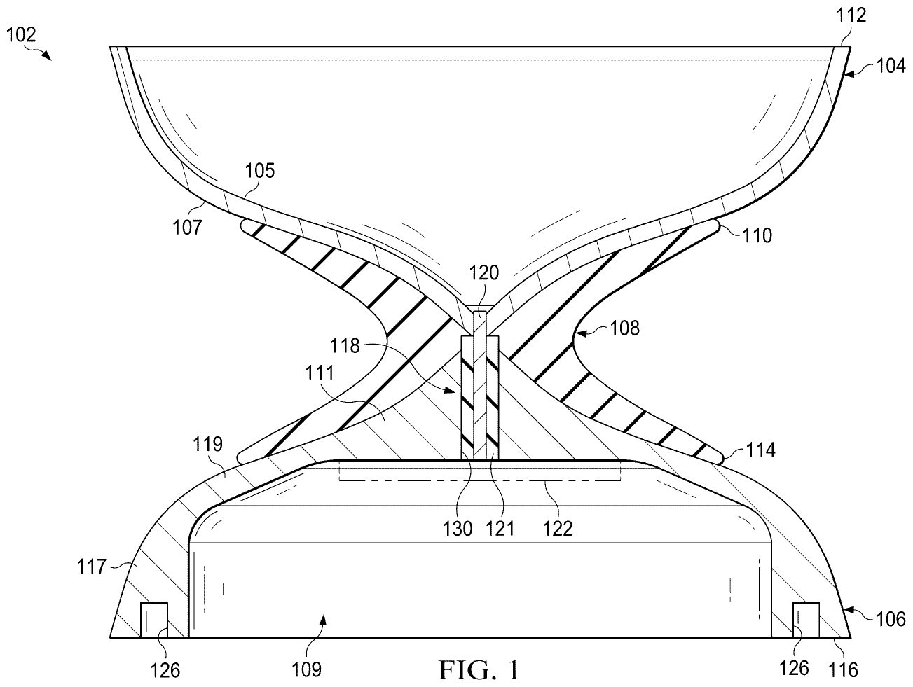

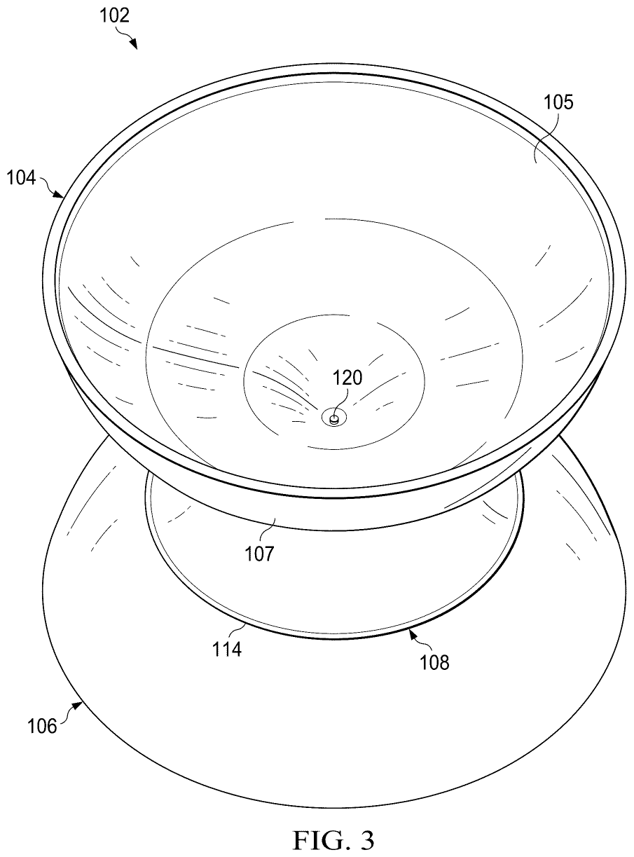

Referring now to the drawings, and more particularly to FIGS. 1-3, there is illustrated a large corset biconical antenna 102 including an upper antenna cone 104 and a lower antenna cone 106 that are interconnected by a dielectric connector corset 108. The upper antenna cone 104 defines an interior surface 105 sloping down to a transmitting metal pin 120 and has an exterior wall 107 having a substantially consistent thickness. The lower antenna cone 106 defines an interior cavity 109 that will be enclosed when the lower antenna cone 106 is connected to a ground plane (not shown). The lower antenna cone 106 includes a thicker conical portion 111 at the small end of the lower antenna cone that defines a passageway 130 through which the metal pin 120 and surrounding insulator 121 are inserted such that the metal pin can come into contact with the upper antenna cone 104. The bottom edge 116 of the lower antenna cone 106 provides a thicker walled portion 117 that interconnects with the thicker conical portion 111 comprising the small end of the lower antenna cone via a thinner intermediate wall portion 119.

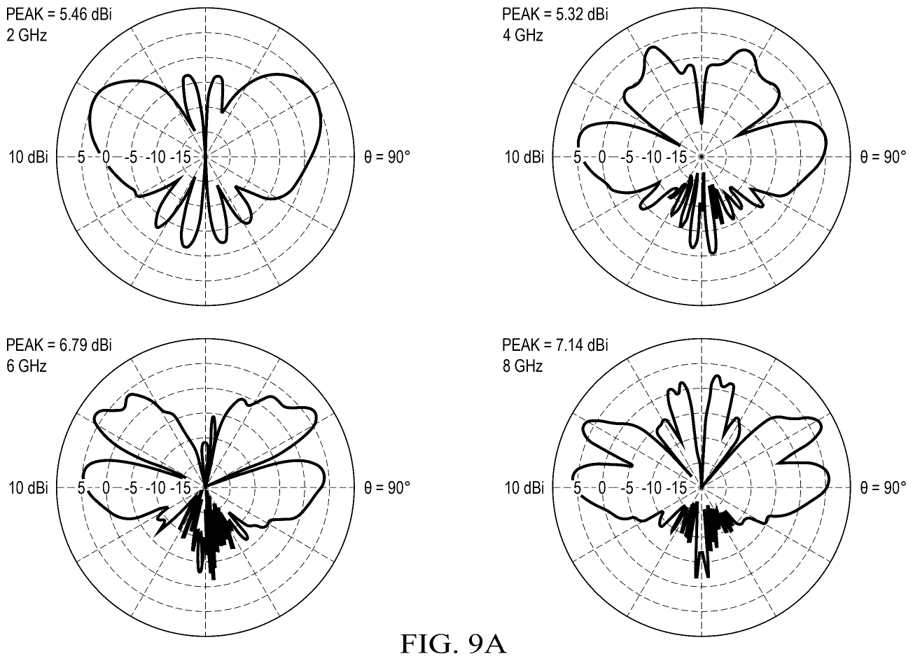

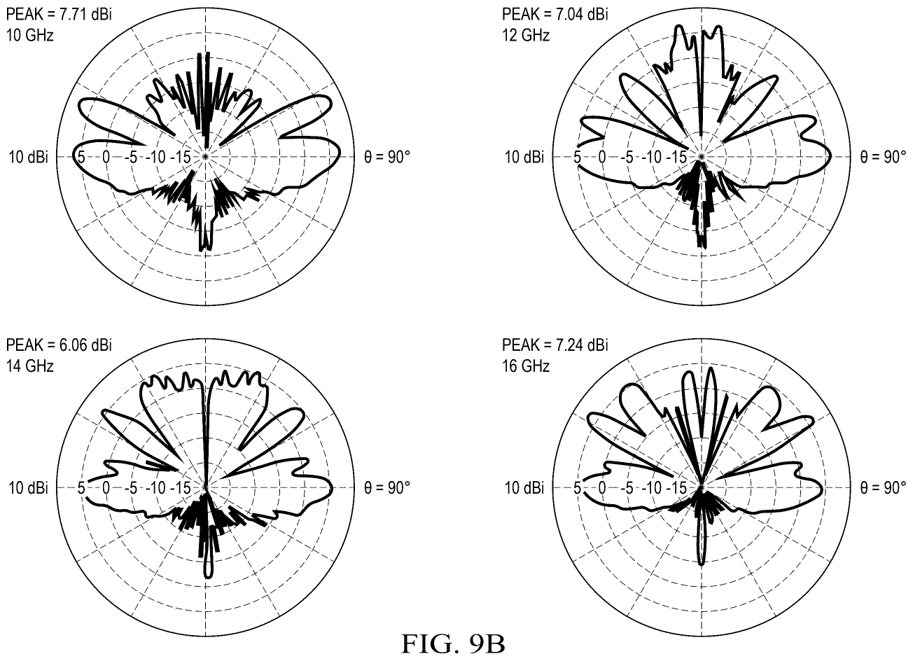

The shape of the upper antenna cone 104 and the lower antenna cone 106 are configured to provide radiated energy that is radially symmetric to the horizon. The biconical antenna 102 of FIG. 1 provides 1-24 GHz performance with consistent gain on horizon over frequency, efficient match performance across frequency, low distortion performance across frequency, mass manufacturing capability, and low radar cross-section performance due to antenna's sloped surfaces. The biconical antenna 102 includes a sinusoidal taper on the walls of the upper antenna cone 104 and the lower antenna cone 106. At the connecting point between the two metallized antenna cones 104, 106 is a coaxially fed radiating metal pin 120 for emitting the RF signal that contacts the upper antenna cone 104. The biconical antenna 102 has radially symmetric coverage over all φ values (0 to 360°) to the horizon. This is beneficial for an omni-directional stand-alone unit. Examples of the radiation patterns for specific frequencies of the biconical antenna 102 are more fully illustrated in FIGS. 9A and 9B. While specific values and ranges are recited herein, it will be appreciated that the biconical antenna 102 is applicable to a variety of frequency ranges and various other values and ranges may be used.

The upper antenna cone 104 and lower antenna cone 106 are bonded to the dielectric connector corset 108 using a bonding agent or some other type of adhesive process that securely fastens the upper antenna cone 104 and the lower antenna cone 106 into the dielectric connector corset 108. As shown in FIG. 11, the upper antenna cone 104 and the lower antenna cone 106 are composed of a base substrate 1102 composed of a dielectric material having a metalized layer 1104 thereon to provide the radiating elements. The dielectric connector corset 108 defines conical-shaped openings that are configured to engage the corresponding exterior surfaces of the upper antenna cone 104 and the lower antenna cone 106. This provides the dielectric connector corset 108 with large open ends on opposite sides thereof into which the upper antenna cone 104 and lower antenna cone 106 may be inserted. The large open ends of the dielectric connector corset 108 shrink down to a center portion that has a substantially smaller width than the two opposing end portions. The top edge of the dielectric connector corset 108 is positioned substantially below the top edge 112 of the upper antenna cone 104 to provide a first side a truncated dielectric lens for increasing the directivity of the antenna patterns of the biconical antenna 102 to the horizon. Similarly, the lower edge 114 is located substantially above the bottom edge 116 of the lower antenna cone 106 to facilitate the other side of the dielectric lens. Placement of the dielectric connector corset 108 improves antenna transmission characteristics by focusing energy to the horizon using the dielectric lens provided by the corset 108, the upper antenna cone 104 and the lower antenna cone 106. The shape of the dielectric connector corset 108 is configured to provide rigid structural support to the placement of upper antenna cone 104 and lower antenna cone 106.

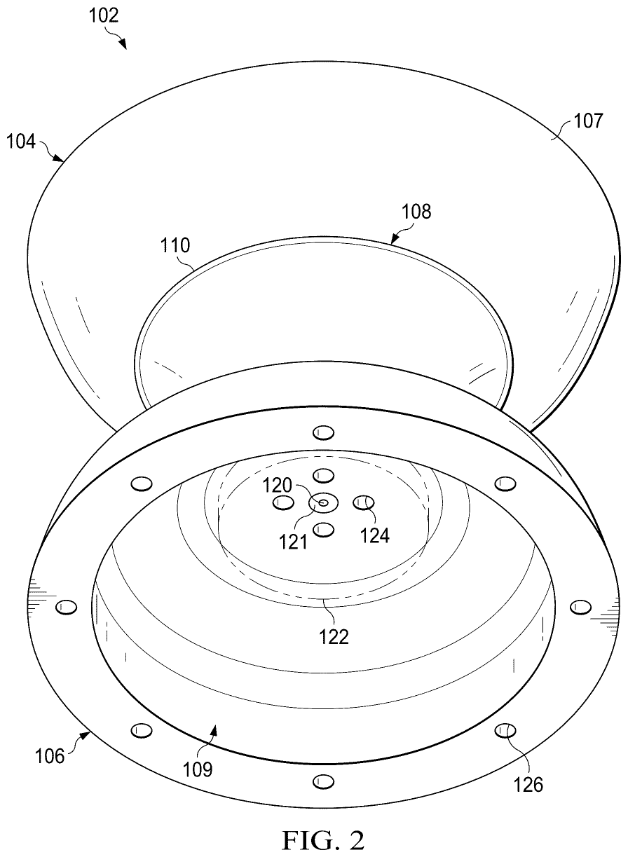

The dielectric connector corset 108 is truncated away from the antenna extents, the very top edge 112 of upper antenna cone 104 and the very bottom edge 116 of lower antenna cone 106, to lessen the amount of dielectric thickness present within the dielectric connector corset in order to avoid regions of frequency where the antenna gain to the horizon would otherwise drop out. An SMA connector 118 has metal pin 120 that is metallically bonded to the upper antenna cone 104. The metal pin 120 is surrounded by an insulator 121 that separates the metal pin from the dielectric connector corset 108 and the passageway 130 of the lower antenna cone 106. The metal pin 120 extends upward from an SMA flange 122 that is connected to an interior surface of the lower antenna cone 106. The SMA flange 122 of the SMA connector 118 is connected with screws to the interior surface of the lower antenna cone 106 secured through holes 124 as shown in FIG. 2. The lower antenna cone 106 is connected to a ground plane for antenna operation. In this case, eight tapped holes 126 are located on the bottom edge 116 of the lower antenna cone 106 for connecting the biconical antenna 102 to a larger ground plane structure.

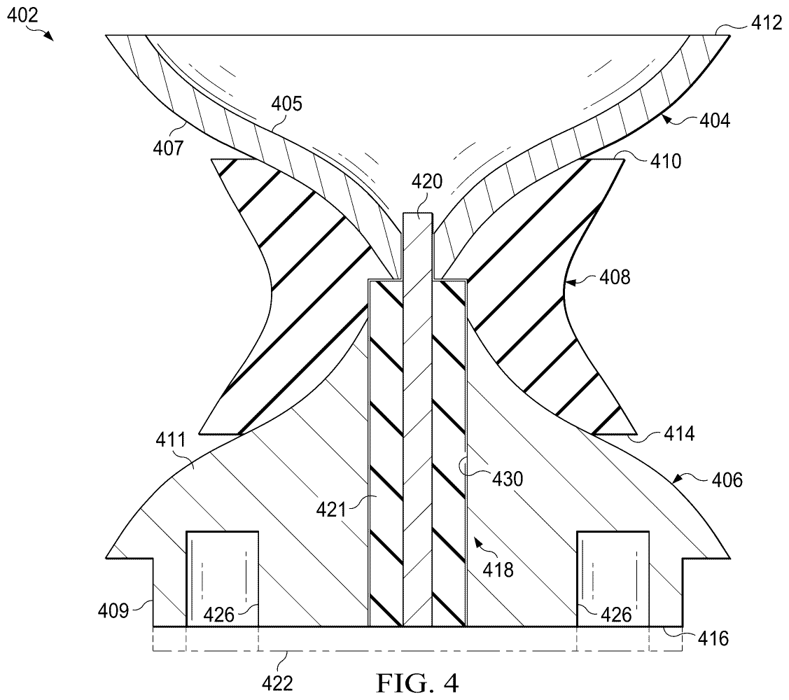

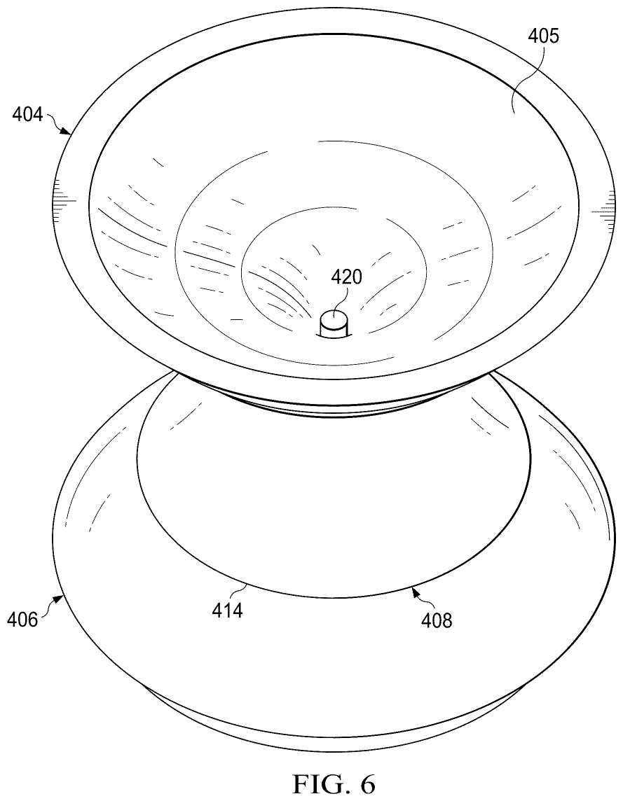

Referring now to the drawings, and more particularly to FIG. 4-6, there is illustrated a small corset biconical antenna 402 including an upper antenna cone 404 and a lower antenna cone 406 that are interconnected by a dielectric connector corset 408. The upper antenna cone 404 defines an interior surface 405 sloping down to a transmitting metal pin 420 and has an exterior wall 407 having a substantially consistent thickness. The lower antenna cone 406 has a solid interior with various passages defined therein. The lower antenna cone 406 includes substantially coned shaped portion 411 that is integrally connected to a cylindrical portion 409. A passageway 430 is defined along the central axis of the lower antenna cone 406 through which the metal pin 420 and surrounding insulator 421 are inserted. The passageway 430 enables the metal pin 420 to come into contact with the upper antenna cone 404.

The shape of the upper cone 404 and the lower cone 406 are configured to provide radiated energy that is radially symmetric to the horizon. The small corset biconical antenna 402 of FIG. 4 provides 1-24 GHz performance with consistent gain on horizon over frequency, efficient match performance across frequency, low distortion performance across frequency, mass manufacturing capability, and low radar cross-section performance due to the antenna's sloped surfaces. The small corset biconical antenna 402 includes a sinusoidal taper on the walls of the upper antenna cone 404 and the lower antenna cone 406. At the connecting point between the two metallized antenna cones 404, 406 the coaxially fed radiating metal pin 420 emits the RF signal. The biconical antenna 402 has radially symmetric coverage over all φ values to the horizon. Examples of the radiation patterns for specific frequencies of the small corset biconical antenna 402 are more fully illustrated in FIGS. 9A and 9B. While specific values and ranges are recited herein, it will be appreciated that the antenna is applicable to a variety of frequency ranges and various other values and ranges may be used.

The upper antenna cone 404 and lower antenna cone 406 are bonded to the dielectric connector corset 408 using a bonding agent or some other type of adhesive process that securely fits the upper antenna cone 404 and the lower antenna cone 406 into the dielectric connector corset 408. The upper antenna cone 404 and the lower antenna cone 406 are composed of a base substrate 1102 of a dielectric material having a metalized layer 1104 thereon to provide the radiating element as shown in FIG. 11. The dielectric connector corset 408 defines conical-shaped openings that are configured to engage the corresponding surface of the upper antenna cone 404 and the lower antenna cone 406. This provides the dielectric connector corset 408 with large open ends on opposite sides thereof into which the upper antenna cone 404 and lower antenna cone 406 may be inserted. The large open ends shrink down to a center portion that has a smaller width than the two opposing end portions. The top edge 410 of the dielectric connector corset 408 is positioned substantially below the top edge 412 of the upper antenna cone 404 to improve transmission characteristics of the biconical antenna 402. Similarly, the lower edge 414 is located substantially above the bottom surface 416 of the lower antenna cone 406. Placement of the dielectric connector corset 408 improves antenna transmission characteristics by focusing energy to the horizon. The shape of the dielectric connector corset 408 is configured to provide rigid structural support to the placement of upper antenna cone 404 and lower antenna cone 406.

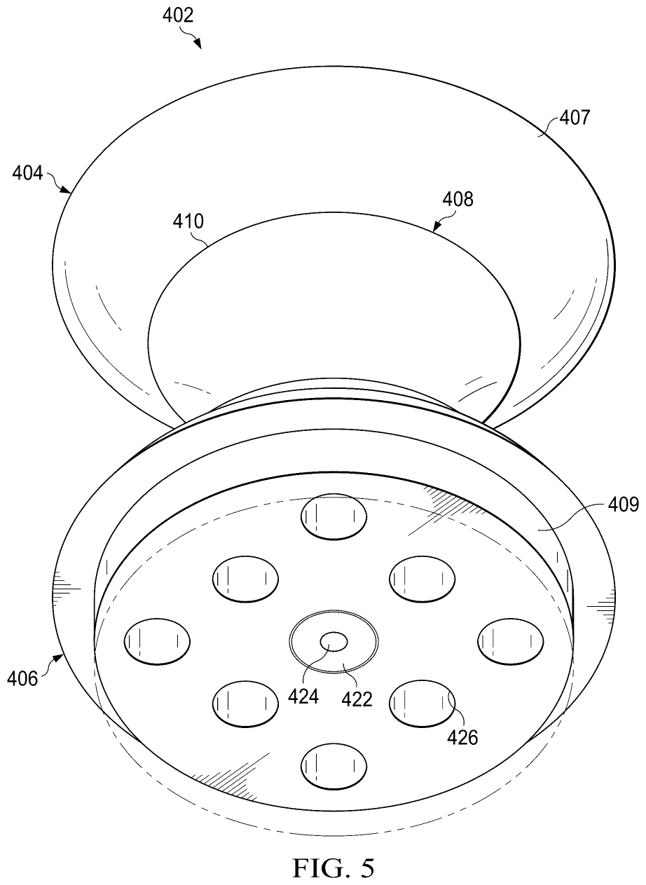

The dielectric connector corset 408 is truncated away from the antenna extents, the very top edge 412 of upper antenna cone 404 and the very bottom surface 416 of lower antenna cone 406, to lessen the amount of dielectric thickness present in order to avoid regions of frequency where the antenna gain to the horizon would otherwise drop out. An SMA connector 418 has metal pin 420 that is metallically bonded to the upper antenna cone 404. The metal pin 420 is surrounded by an insulator 421 that separates the metal pin from the dielectric connector corset 408 and the lower antenna cone 406. The metal pin 420 extends upward from an SMA flange 422 that is connected to the bottom surface 416 cylindrical portion 409. The SMA flange 422 of the SMA connector 418 is connected with screws to the bottom surface 416 of the lower antenna cone 106 secured through holes 424 as shown in FIG. 5. The lower antenna cone 406 is connected to a ground plane for antenna operation. In this case, eight tapped holes 426 are located on the bottom surface 416 of the lower antenna cone 406 for connecting the biconical antenna 402 to a larger ground plane structure.

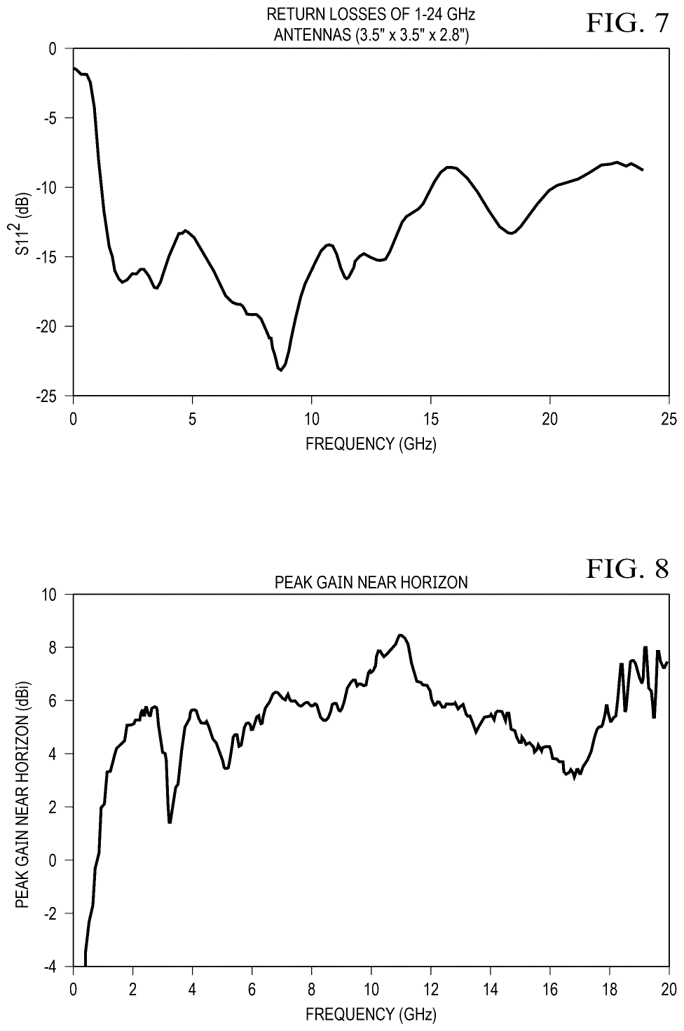

Referring now to FIG. 7, a return loss over frequency curve shows good matching from 1 GHz to 24 GHz for the large corset biconical antenna.

FIG. 8 illustrates a gain over frequency curve that shows useful gain over a very large bandwidth from 1 GHz to 20 GHz for the large biconical antenna.

FIGS. 9A and 9B illustrate elevation gain patterns from 2 GHz to 16 GHz, stepped every 2 GHz are shown for the large biconical antenna. These elevation cuts show desired gain focused to the horizon (θ=90°). Frequencies not shown operate in a similar manner.

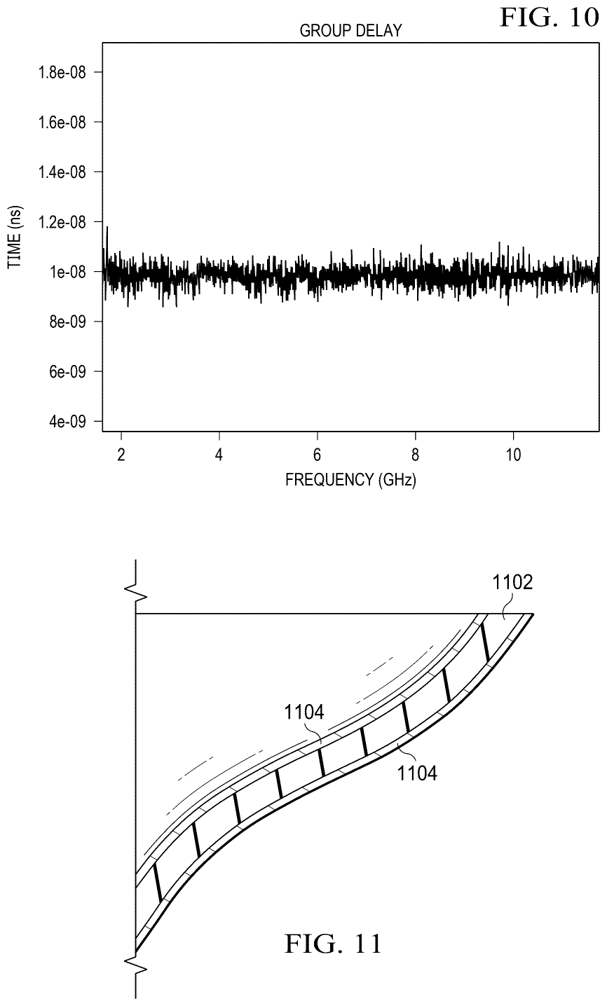

FIG. 10 illustrates the group delay that is computed from the S₂₁ phase slope. The group delay for the large biconical antenna over frequency is extremely flat which is an indication of very low distortion. Low distortion is advantageous in all sorts of communication systems.

It will be appreciated by those skilled in the art having the benefit of this disclosure that this biconical antenna supported by a corset-styled dielectric shroud provides an improved emitting antenna in a more compact package. It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

What is claimed is:

1. A biconical antenna, comprising:
a dielectric corset having a first conical chamber defined therein and a second conical chamber defined therein opposite the first conical chamber, the dielectric corset further defining a passage from the second conical chamber to the first conical chamber;
a first conical radiating structure bonded within the first conical chamber of the dielectric corset;
a second conical radiating structure bonded within the second conical chamber of the dielectric corset; and
an SMA connector connected to the second conical radiating structure and having a metal pin extending through the passage to electrically contact the first conical radiating structure and provide RF signals thereto.

2. The biconical antenna of claim 1 further comprising:
wherein the first conical radiating structure defines a first sinusoidal surface; and
wherein the second conical radiating structure defines a second sinusoidal surface.

3. The biconical antenna of claim 1, wherein each of the first conical radiating structure and the second conical radiating structure further comprises:
a base substrate; and
a metalized layer surrounding the base substrate to conduct the RF signals received from the metal pin of the SMA connector.

4. The biconical antenna of claim 1 further comprising an insulator surrounding the metal pin of the SMA connector within the passage to insulate the metal pin from the second conical radiating structure and the dielectric corset.

5. The biconical antenna of claim 1, wherein the first conical radiating structure and the second conical radiating structure radiates energy that is radially symmetric to a horizon responsive to the RF signals.

6. The biconical antenna of claim 1 further comprising:
wherein a top edge of the first conical radiating structure is located above a top edge of the dielectric corset to avoid regions of frequency that would cause antenna gains to a horizon to drop out; and
wherein a bottom edge of the second conical radiating structure is located below a bottom edge of the dielectric corset to avoid the regions of the frequency that would cause the antenna gains to the horizon to drop out.

7. The biconical antenna of claim 1, wherein the second conical radiating structure defines a chamber therein in addition to the passage.

8. The biconical antenna of claim 1, wherein the second conical radiating structure comprises a solid structure for defining the passage.

9. The biconical antenna of claim 1, wherein the SMA connector further comprises an SMA flange having the metal pin substantially perpendicularly connected to the SMA flange, wherein the SMA flange is configured to be connected to the second conical radiating structure.

10. A biconical antenna, comprising:
a dielectric corset having a first conical chamber defined therein and a second conical chamber defined therein opposite the first conical chamber, the dielectric corset further defining a passage from the second conical chamber to the first conical chamber;
a first conical radiating structure bonded within the first conical chamber of the dielectric corset, the first conical radiating structure defining a first sinusoidal surface, wherein the first conical radiating structure further comprises:
a first base substrate;
a first metalized layer surrounding the first base substrate to conduct RF signals;
a second conical radiating structure bonded within the second conical chamber of the dielectric corset, the second conical radiating structure defining a second sinusoidal surface, wherein the second conical radiating structure further comprises:
a second base substrate;
a second metalized layer surrounding the second base substrate to conduct the RF signals;
an SMA connector connected to the second conical radiating structure and having a metal pin extending through the passage to electrically contact the first metalized layer of the first conical radiating structure and provide RF signals thereto; and
an insulator surrounding the metal pin of the SMA connector within the passage to insulate the metal pin from the second conical radiating structure and the dielectric corset.

11. The biconical antenna of claim 10, wherein the first conical radiating structure and the second conical radiating structure radiates energy that is radially symmetric to a horizon responsive to the RF signals.

12. The biconical antenna of claim 10 further comprising:
wherein a top edge of the first conical radiating structure is located above a top edge of the dielectric corset to avoid regions of frequency that would cause antenna gains to a horizon to drop out; and
wherein a bottom edge of the second conical radiating structure is located below a bottom edge of the dielectric corset to avoid the regions of the frequency that would cause the antenna gains to the horizon to drop out.

13. The biconical antenna of claim 10, wherein the second conical radiating structure defines a chamber therein in addition to the passage.

14. The biconical antenna of claim 10, wherein the second conical radiating structure comprises a solid structure for defining the passage.

15. The biconical antenna of claim 10, wherein the SMA connector further comprises an SMA flange having the metal pin substantially perpendicularly connected to the SMA flange, wherein the SMA flange is configured to be connected to the second conical radiating structure.

16. A biconical antenna, comprising:
a dielectric corset having a first conical chamber defined therein and a second conical chamber defined therein opposite the first conical chamber, the dielectric corset further defining a passage from the second conical chamber to the first conical chamber;
a first conical radiating structure bonded within the first conical chamber of the dielectric corset, wherein a top edge of the first conical radiating structure is located above a top edge of the dielectric corset to avoid regions of frequency that would cause antenna gains to a horizon to drop out;
a second conical radiating structure bonded within the second conical chamber of the dielectric corset, wherein a bottom edge of the second conical radiating structure is located below a bottom edge of the dielectric corset to avoid the regions of the frequency that would cause the antenna gains to the horizon to drop out;
an SMA connector connected to the second conical radiating structure and having a metal pin extending through the passage to electrically contact the first conical radiating structure and provide RF signals thereto; and
wherein the first conical radiating structure and the second conical radiating structure radiates energy that radially symmetric to the horizon responsive to the RF signals.

17. The biconical antenna of claim 16 further comprising:
wherein the first conical radiating structure defines a first sinusoidal surface; and
wherein the second conical radiating structure defines a second sinusoidal surface.

18. The biconical antenna of claim 16, wherein each of the first conical radiating structure and the second conical radiating structure further comprises:
a base substrate; and
a metalized layer surrounding the base substrate to conduct the RF signals received from the metal pin of the SMA connector.

19. The biconical antenna of claim 16 further comprising an insulator surrounding the metal pin of the SMA connector within the passage to insulate the metal pin from the second conical radiating structure and the dielectric corset.

20. The biconical antenna of claim 16, wherein the SMA connector further comprises an SMA flange having the metal pin substantially perpendicularly connected to the SMA flange, wherein the SMA flange is configured to be connected to the second conical radiating structure.
